(19) United States
(12) Patent Application Publication
(10) Pub. No.: US 2026/0244760 A1
(43) Pub. Date: Aug. 20, 2026

(54) TEXT PROCESSING APPARATUS, TEXT PROCESSING METHOD, AND RECORDING MEDIUM

(71) Applicant: NEC Corporation, Tokyo (JP)

(72) Inventors: Mamoru SAITA, Tokyo (JP); Hirofumi UEDA, Tokyo (JP); Norio YAMAGAKI, Tokyo (JP); Shunichi KINOSHITA, Tokyo (JP)

(73) Assignee: NEC Corporation, Tokyo (JP)

(21) Appl. No.: 19/411,626

(22) Filed: Dec. 8, 2025

(30) Foreign Application Priority Data
Feb. 14, 2025 (JP) 2025-022136

(51) Int. Cl. G06F 21/57; G06F 40/295; G06F 40/30

(52) U.S. Cl. CPC G06F 21/577; G06F 40/295; G06F 40/30

(57) ABSTRACT

An extraction unit extracts damage information including a keyword related to content of a case of damage caused by a certain type of vulnerability in information security, from a document describing the case of damage; a generation unit generates an explanation regarding the case of damage by using the damage information extracted from the document; and an output unit outputs information based on the generated explanation.

This application is based upon and claims the benefit of priority from Japanese patent application No. 2025-022136, filed on Feb. 14, 2025, the disclosure of which is incorporated herein in its entirety by reference.

### TECHNICAL FIELD

The present disclosure relates to a text processing apparatus, a text processing method, and a recording medium, and more particularly to a text processing apparatus, a text processing method, and a recording medium for generating a summary of a document.

### BACKGROUND ART

In an example of a related technology, a summary (summarizing key points) of a document is generated by using a pre-trained language model (large language model (LLM), small language model (SLM), or the like). Specifically, in a related technology, a prompt that instructs generation of a summary of a document is input to a language model together with data of the document. The language model generates and outputs a summary of the input document based on content of the instruction.

PTL 1 (Japanese Patent No. 7458543) discloses that, with reference to an input query, one or more matching chunks corresponding to the query are extracted from one or more target chunks, and an instruction for generating a summary of the one or more target chunks is input to a language model.

### SUMMARY

There may be a large number of documents (for example, news articles or reports) that describe cases of damage regarding a certain type of vulnerability in information security. In a case where data of such a large amount of documents is directly input to a language model that generates a summary, there is a possibility that some of main content of the cases of damage is omitted from the summary generated by the language model.

The present disclosure has been made in view of the above-described problem, and an object of the present disclosure is to ensure that information regarding cases of damage regarding a certain type of vulnerability in information security is included in a summary of documents that describe such cases of damage.

A text processing apparatus according to an aspect of the present
disclosure includes a memory configured to store instructions; and at
least one processor configured to execute the instructions to perform: extracting damage information including a keyword related to content of a case of damage caused by a certain type of vulnerability in information
security, from a document describing the case of damage; generating an explanation regarding the case of damage by using the damage information
extracted from the document; and outputting information based on the generated explanation.

A text processing method according to an aspect of the present disclosure is executed by a computer, and includes extracting damage information including a keyword related to content of a case of damage caused by a certain type of vulnerability in information security, from a document describing the case of damage; generating an explanation regarding the case of damage by using the damage information extracted from the document; and outputting information based on the generated explanation.

A recording medium according to an aspect of the present disclosure stores a program for causing a computer to execute process of extracting damage information including a keyword related to content of a case of damage caused by a certain type of vulnerability in information security, from a document describing the case of damage; process of generating an explanation regarding the case of damage by using the damage information extracted from the document; and process of outputting information based on the generated explanation.

According to the aspect of the present disclosure, it is possible to ensure that information regarding a case of damage regarding a certain type of vulnerability in information security is included in a summary of a document describing the case of damage.

### BRIEF DESCRIPTION OF THE DRAWINGS

FIG. 1 is a block diagram illustrating a configuration of a text processing apparatus according to one example embodiment;

FIG. 2 illustrates examples of documents describing cases of damage (article A, article B);

FIG. 3 illustrates an example of damage information;

FIG. 4 illustrates an example of an explanation regarding a case of damage;

FIG. 5 is a flowchart illustrating an operation of a text processing apparatus according to one example embodiment;

FIG. 6 is a diagram illustrating an example of a system including a text processing apparatus according to one example embodiment;

FIG. 7 illustrates an example of a first prompt;

FIG. 8 illustrates an example of a damage information database (DB);

FIG. 9 is a flowchart illustrating an operation of a text processing apparatus according to one example embodiment;

FIG. 10 is a diagram illustrating an example of a system including a text processing apparatus according to one example embodiment;

FIG. 11 illustrates an example of a second prompt;

FIG. 12 illustrates another example of a second prompt;

FIG. 13 illustrates an example of knowledge information stored in a knowledge information DB;

FIG. 14 is a flowchart illustrating an operation of a text processing apparatus according to one example embodiment;

FIG. 15 is a diagram illustrating an example of a system including a text processing apparatus according to one example embodiment;

FIG. 16 is a flowchart illustrating an operation of a text processing apparatus according to one example embodiment; and

FIG. 17 is a diagram illustrating an example of a hardware configuration of a text processing apparatus according to one example embodiment.

### EXAMPLE EMBODIMENT

### First Example Embodiment

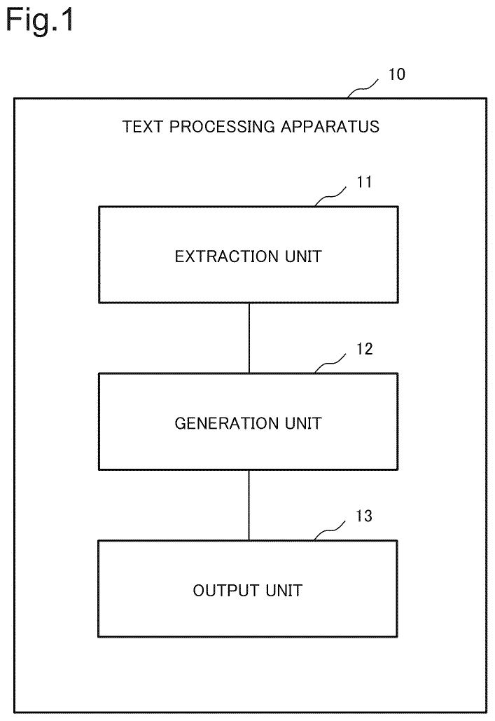

A first example embodiment of the present disclosure will be described with reference to FIGS. 1 to 5.

### Configuration of Text Processing Apparatus 10

FIG. 1 is a block diagram illustrating a configuration of a text processing apparatus 10 according to the first example embodiment. As illustrated in FIG. 1, the text processing apparatus 10 includes an extraction unit 11, a generation unit 12, and an output unit 13.

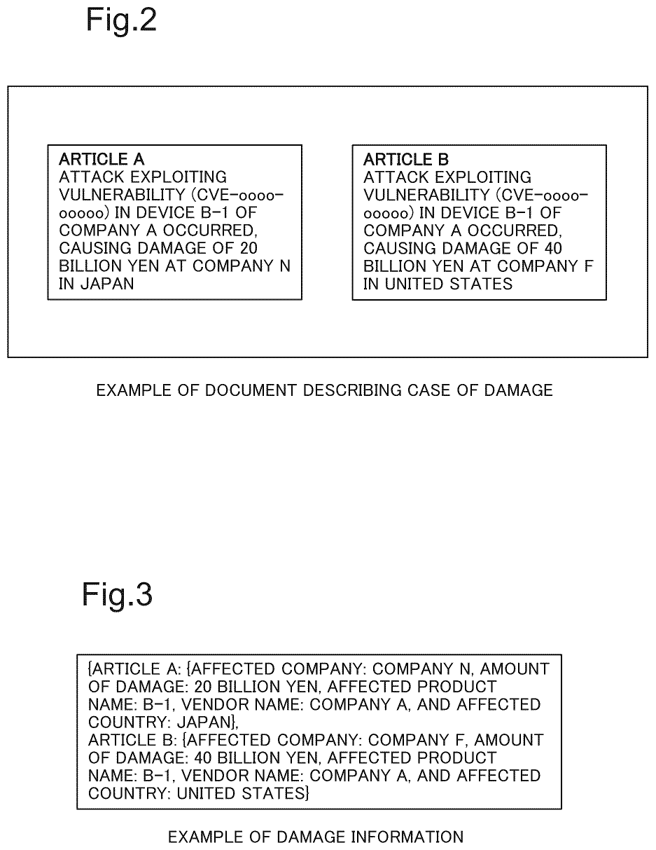

The extraction unit 11 extracts damage information (FIG. 3), which includes a keyword related to content of a case of damage, from documents (FIG. 2) describing the case of damage caused by a certain type of vulnerability in information security. The extraction unit 11 is an example of extraction means. For example, the keyword related to the content of the case of damage includes an affected company name, an affected product name, a vendor name, and an affected country name.

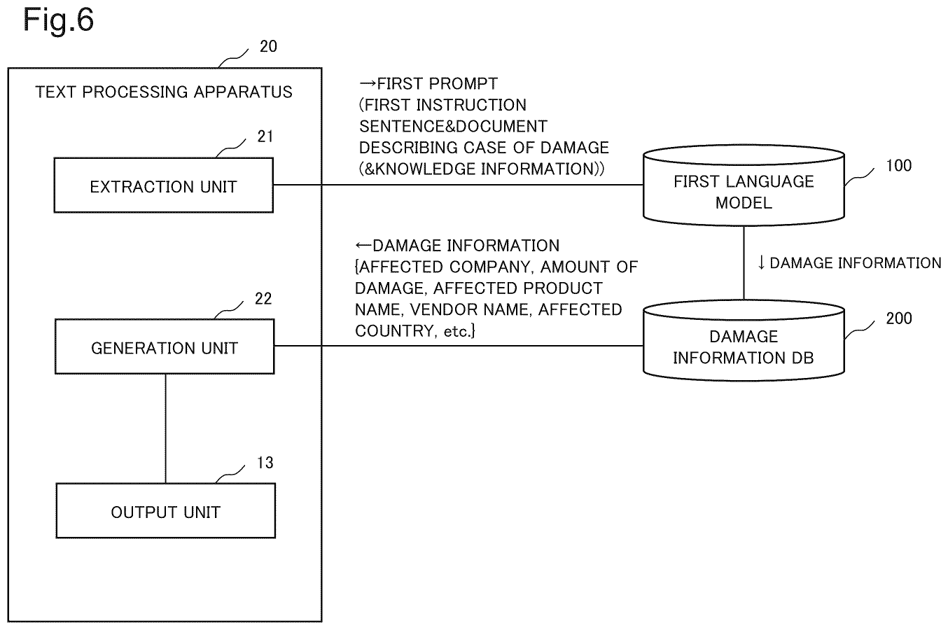

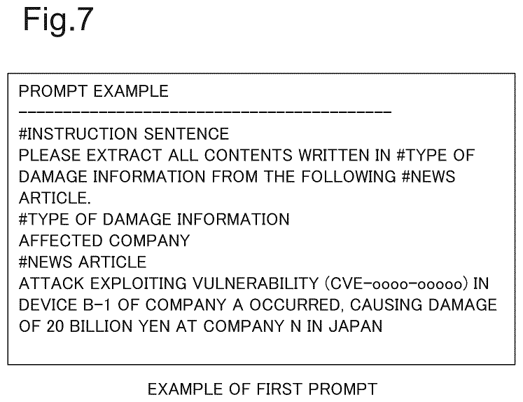

Alternatively, the extraction unit 11 may input, to a first language model 100 (FIG. 6), a first prompt (FIG. 7) that includes a first instruction sentence for designating a keyword related to the content of the case of damage and a document. Then, the extraction unit 11 may cause the first language model 100 to output, from the input document, damage information including a keyword related to the content of the case of damage.

In another example, the extraction unit 11 may cause the first language model 100 to refer to basic information regarding a certain type of vulnerability in information security and to extract a keyword related to the content of the case of damage from the input document.

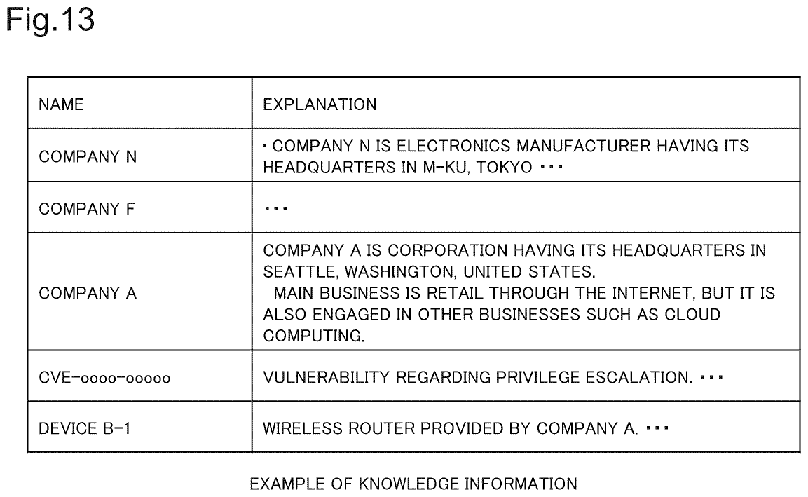

Alternatively, the extraction unit 11 may further input, to the first language model 100, knowledge information (FIG. 13) regarding content of a case of damage, and may cause the first language model 100 to refer to the input knowledge information and to extract a keyword related to the content of the case of damage from the input document (modified example of a second example embodiment).

The extraction unit 11 outputs, to the generation unit 12, damage information including the keyword extracted from the input document.

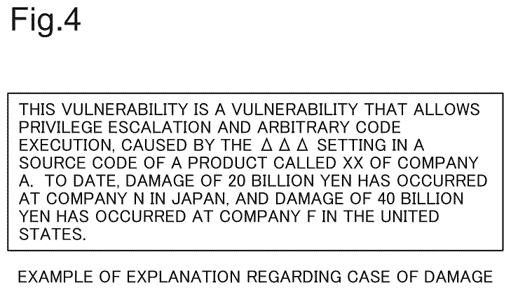

The generation unit 12 generates an explanation regarding the case of damage by using the damage information extracted from the document. The generation unit 12 is an example of a generation means. The explanation regarding the case of damage means information expressed in a document, which indicates a target (for example, an affected company) that sustained damage resulting from a certain type of vulnerability in information security, content of the damage (for example, the scale and scope of the damage), a date and time of occurrence of the damage, and a place of occurrence of the damage (for example, a country or region). A specific example of the explanation regarding a case of damage will be described later (FIG. 4).

For example, the generation unit 12 receives damage information from the extraction unit 11. The generation unit 12 refers to the damage information received from the extraction unit 11, and generates an explanation regarding the case of damage.

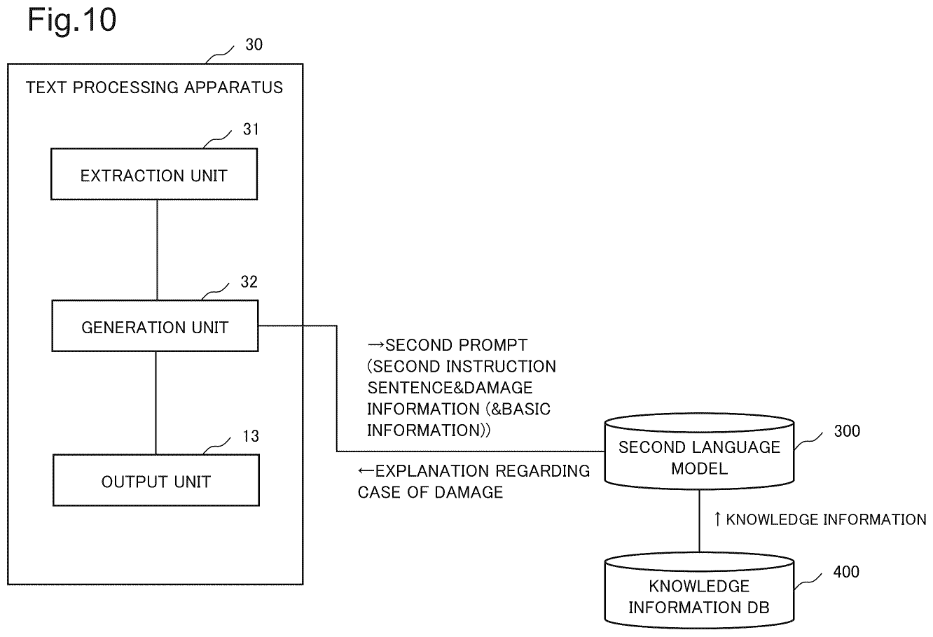

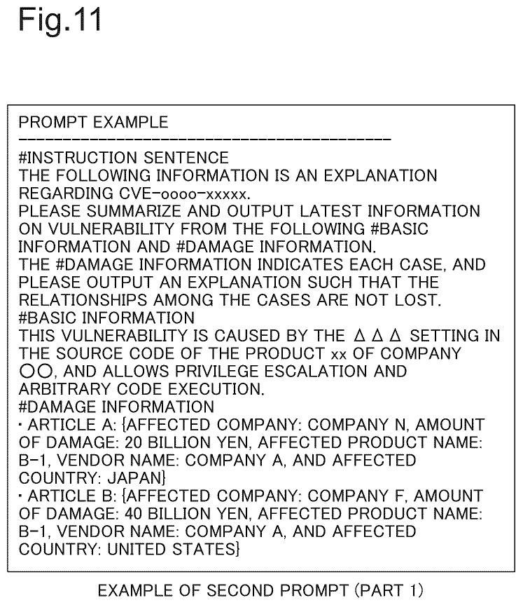

In another example, the generation unit 12 inputs, to a second language model 300 (FIG. 10), a second prompt (FIG. 11) that includes a second instruction sentence for instructing generation of an explanation regarding the case of damage, the damage information, and the basic information, and causes the second language model 300 to output an explanation regarding the case of damage (third example embodiment).

Alternatively, the generation unit 12 may further input, to the second language model 300, basic information regarding a certain type of vulnerability in information security, and may cause the second language model 300 to refer to the basic information and to output the above explanation regarding the case of damage from the damage information and the basic information (third example embodiment).

Alternatively, the generation unit 12 may refer to a knowledge information DB 400 (FIG. 10), further input knowledge information (FIG. 13) regarding the content of a case of damage to the second language model 300, and may cause the second language model 300 to refer to the knowledge information and to output an explanation regarding the case of damage from the damage information and the knowledge information (a modified example of the third example embodiment).

The generation unit 12 outputs the explanation regarding the case of damage to the output unit 13.

The output unit 13 outputs information based on the explanation generated by the generation unit 12. The output unit 13 is an example of output means. The information based on the explanation regarding the case of damage is an example of a summary of a document describing the case of damage, and, for example, is a converted version of the above explanation regarding the case of damage in accordance with settings such as a format, display style, character limit, and language. It may be possible for a user to freely change the settings.

For example, the output unit 13 receives the explanation regarding the case of damage from the generation unit 12. The output unit 13 outputs, to an external device (not illustrated) such as a user terminal, either information based on the explanation regarding the case of damage or the explanation regarding the case of damage itself generated by the generation unit 12.

As described above, the text processing apparatus 10 first extracts damage information from a document, then generates an explanation regarding the case of damage by using the extracted damage information, and outputs the explanation. Therefore, the output explanation (summary) includes damage information including a keyword related to content of a case of damage. As a result, the user can accurately know the information regarding the case of damage.

### Example of Document Describing Case of Damage

FIG. 2 illustrates examples of documents describing cases of damage. In FIG. 2, two articles A and B (examples of documents describing cases of damage) are illustrated. The article A describes that “attack exploiting vulnerability (CVE-oooo-ooooo) in device B-1 of company A occurred, causing damage of 20 billion yen at company N in Japan”. The article B describes that “attack exploiting vulnerability (CVE-oooo-ooooo) in device B-1 of company A occurred, causing damage of 40 billion yen at company F in the United States”.

Both the article A and the article B are documents describing cases of damage due to the same vulnerability. Note that the articles A and B illustrated in FIG. 2 are merely examples of documents describing cases of damage caused by a vulnerability.

### Example of Damage Information

FIG. 3 illustrates an example of damage information extracted by the extraction unit 11 from the documents (FIG. 2) describing cases of damage. In the example illustrated in FIG. 3, the damage information includes an “affected company”, an “amount of damage”, an “affected product name”, a “vendor name”, and an “affected country”. The damage information may also include information other than these pieces of information.

In FIG. 3, as damage information extracted from the above-described article A (FIG. 2), “affected company: company N”, “amount of damage: 20 billion yen”, “affected product name: B-1”, “vendor name: company A”, and “affected country: Japan” are illustrated. In addition, as damage information extracted from the above-described article B (FIG. 2), “affected company: company F”, “amount of damage: 40 billion yen”, “affected product name: B-1”, “vendor name: company A”, and “affected country: the United States” are illustrated.

Example of Explanation regarding Case of Damage

FIG. 4 illustrates an example of an explanation regarding a case of damage generated by the generation unit 12. In the example illustrated in FIG. 4, “this vulnerability is a vulnerability that allows privilege escalation and arbitrary code execution, caused by the ΔΔΔ setting in a source code of a product called xx of company A. To date, damage of 20 billion yen has occurred at company N in Japan, and damage of 40 billion yen has occurred at company F in the United States” is described. This explanation is generated by the generation unit 12 based on the damage information illustrated in FIG. 3.

### Operation of Text Processing Apparatus 10

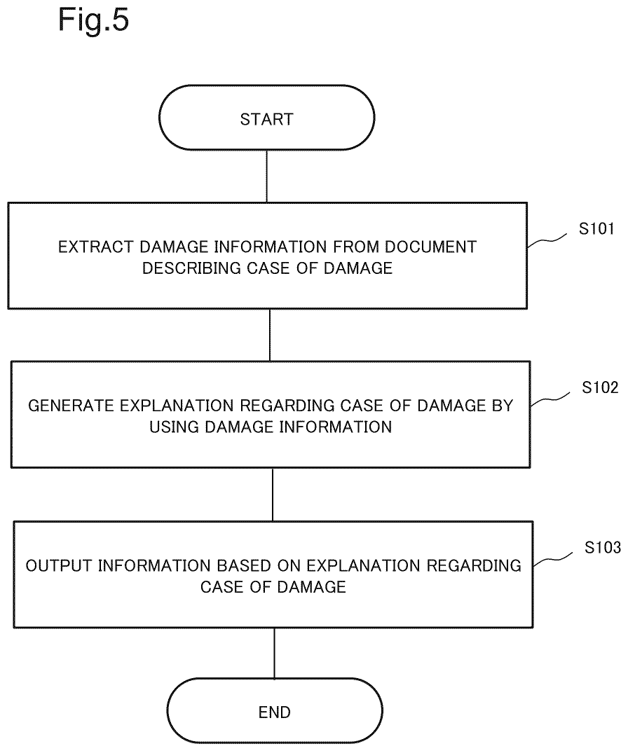

An operation of the text processing apparatus 10 according to the first example embodiment will be described with reference to FIG. 5. FIG. 5 is a flowchart illustrating an operation of the text processing apparatus 10 according to the first example embodiment.

As illustrated in FIG. 5, the extraction unit 11 extracts damage information which includes a keyword related to content of a case of damage, from a document describing the case of damage caused by a certain type of vulnerability in information security (S101). The extraction unit 11 outputs the damage information extracted from the input document, to the generation unit 12.

Next, the generation unit 12 generates an explanation regarding the case of damage by using the damage information extracted from the document describing the case of damage (S102). The generation unit 12 outputs the explanation regarding the case of damage to the output unit 13.

Then, the output unit 13 outputs information based on the generated explanation (S103).

As described above, the operation of the text processing apparatus 10 according to the first example embodiment ends.

### Effects of Present Example Embodiment

With the configuration of the present example embodiment, the extraction unit 11 extracts damage information which includes keyword related to content of the case of damage, from the document describing the case of damage caused by a certain type of vulnerability in information security. The generation unit 12 generates an explanation regarding the case of damage by using the damage information extracted from the document. The output unit 13 outputs information based on the generated explanation. In this manner, the text processing apparatus 10 first extracts damage information from a document, then generates an explanation regarding the case of damage by using the extracted damage information, and outputs the explanation. Therefore, the output explanation (summary) includes damage information including a keyword related to content of a case of damage.

As a result, it is possible to ensure that information regarding a case of damage regarding a certain type of vulnerability in information security is included in a summary of a document describing the case of damage.

### Second Example Embodiment

A second example embodiment of the present disclosure will be described with reference to FIGS. 6 to 9. In the second example embodiment, the same components as those in the first example embodiment are denoted by the same reference numerals as those in the first example embodiment, and the description thereof may be omitted.

### Configuration of Text Processing Apparatus 20

FIG. 6 is a block diagram illustrating a configuration of a text processing apparatus 20 according to the second example embodiment. As illustrated in FIG. 6, the text processing apparatus 20 includes an extraction unit 21, a generation unit 22, and the output unit 13.

The extraction unit 21 inputs, to the first language model 100, the first prompt (FIG. 7) that includes the first instruction sentence for designating a keyword related to the content of the case of damage and the document describing the case of damage. Then, the extraction unit 21 may cause the first language model 100 to output, from the input document, damage information including a keyword related to the content of the case of damage. The extraction unit 21 is an example of extraction means. For example, the keyword related to the content of the case of damage includes an affected company name, an affected product name, a vendor name, and an affected country name.

Alternatively, the extraction unit 21 further inputs, to the first language model 100, basic information regarding a certain type of vulnerability in information security, and causes the first language model 100 to refer to the input basic information and to extract a keyword related to the content of the case of damage from the document describing the case of damage.

In a modified example, the extraction unit 21 may further input, to the first language model 100, knowledge information (FIG. 10) regarding the content of the case of damage, and may cause the first language model 100 to extract a keyword related to the content of the case of damage from the document describing the case of damage by further using the input knowledge information. For example, the knowledge information includes a “name” of an organization such as a company and an “explanation” regarding the organization (FIG. 13).

The extraction unit 21 stores the damage information including the keyword extracted from the document describing the case of damage, in a damage information database (DB) 200.

The generation unit 22 generates an explanation regarding the case of damage with reference to the damage information stored in the damage information DB 200.

For example, the generation unit 22 generates an explanation (FIG. 4) regarding the case of damage with reference to the damage information stored in the damage information DB 200 by the extraction unit 21.

The generation unit 22 outputs the explanation regarding the case of damage generated based on the damage information, to the output unit 13.

Similarly to the first example embodiment, the output unit 13 outputs information based on the explanation generated by the generation unit 22.

For example, the output unit 13 receives the explanation regarding the case of damage from the generation unit 22. The output unit 13 outputs, to an external device (not illustrated) such as a user terminal, either information based on the explanation regarding the case of damage or the explanation regarding the case of damage itself generated by the generation unit 22.

### Example of First Prompt

FIG. 7 illustrates an example of the first prompt that includes the first instruction sentence for designating a keyword related to the content of the case of damage and the document describing the case of damage. In the example illustrated in FIG. 7, the first instruction sentence is “please extract all contents written in #type of damage information from the following #news article”. Here, as “#type of damage information”, “affected company” is designated. The document describing the case of damage is “#news article: attack exploiting vulnerability (CVE-oooo-ooooo) in device B-1 of company A occurred, causing damage of 20 billion yen at company N in Japan”.

### Example of Damage Information DB 200

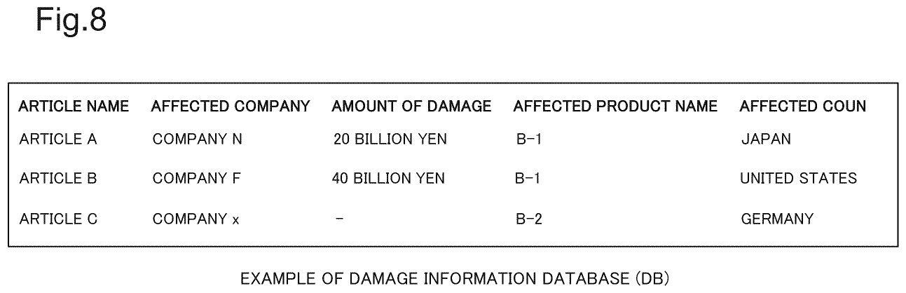

FIG. 8 illustrates an example of a data structure of the damage information DB 200 in which the damage information generated by the first language model 100 (FIG. 6) is stored. In the example illustrated in FIG. 8, the damage information DB 200 includes damage information such as an “article name”, an “affected company”, an “amount of damage”, an “affected product name”, and an “affected country”. For example, in the second row of the damage information DB 200, the “article name” is “article A”, the “affected company” is “company N”, the “amount of damage” is “20 billion yen”, the “affected product name” is “B-1”, and the “affected country” is “Japan”.

### Operation of Text Processing Apparatus 20

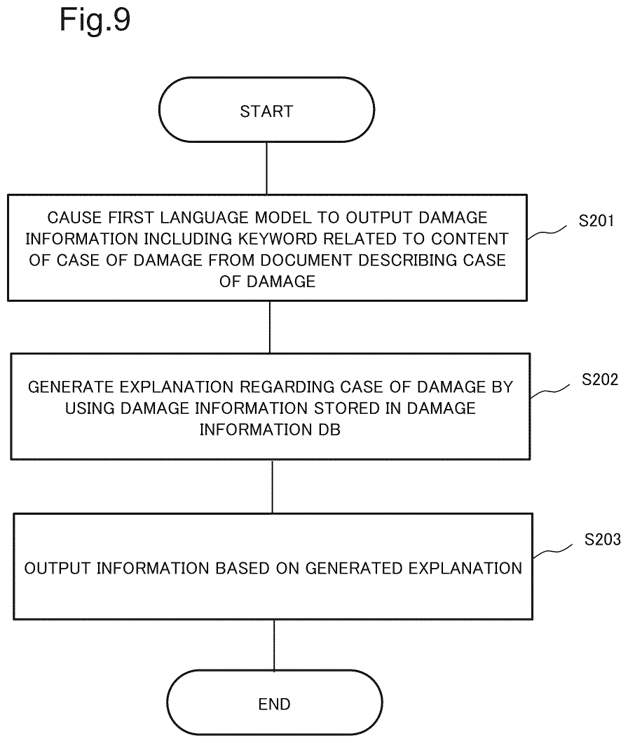

An operation of the text processing apparatus 20 according to the second example embodiment will be described with reference to FIG. 9. FIG. 9 is a flowchart illustrating an operation of the text processing apparatus 20 according to the second example embodiment.

As illustrated in FIG. 9, the extraction unit 21 causes the first language model 100 to output damage information which includes a keyword related to content of a case of damage, from a document describing the case of damage caused by a certain type of vulnerability in information security (S201). The extraction unit 21 stores the damage information extracted from the input document, in the damage information DB 200.

Next, the generation unit 22 generates an explanation regarding the case of damage by using the damage information stored in the damage information DB 200 (S202). The generation unit 22 outputs the explanation regarding the case of damage to the output unit 13.

Then, the output unit 13 outputs information based on the generated explanation (S203).

As described above, the operation of the text processing apparatus 20 according to the second example embodiment ends.

### Effects of Present Example Embodiment

With the configuration of the present example embodiment, the extraction unit 21 causes the first language model 100 to output damage information which includes a keyword related to content of a case of damage, from a document describing the case of damage caused by a certain type of vulnerability in information security. The generation unit 22 generates an explanation regarding the case of damage by using the damage information stored in the damage information DB 200. The output unit 13 outputs information based on the generated explanation.

In this manner, the text processing apparatus 20 first extracts damage information from a document, then generates an explanation regarding the case of damage by using the extracted damage information, and outputs the explanation. Therefore, the output explanation (summary) includes damage information including a keyword related to content of a case of damage.

As a result, it is possible to ensure that information regarding a case of damage regarding a certain type of vulnerability in information security is included in a summary of a document describing the case of damage.

### Third Example Embodiment

A third example embodiment of the present disclosure will be described with reference to FIGS. 10 to 14. In the third example embodiment, the same components as those in the first example embodiment are denoted by the same reference numerals as those in the first example embodiment, and the description thereof may be omitted.

### Configuration of Text Processing Apparatus 30

FIG. 10 is a block diagram illustrating a configuration of a text processing apparatus 30 according to the third example embodiment. As illustrated in FIG. 10, the text processing apparatus 30 includes an extraction unit 31, a generation unit 32, and the output unit 13.

The extraction unit 31 extracts damage information (FIG. 3), which includes a keyword related to content of a case of damage, from the documents (FIG. 2) describing the cases of damage caused by a vulnerability.

Alternatively, similarly to the extraction unit 21 of the second example embodiment, the extraction unit 31 may further input, to the first language model 100 (FIG. 6), knowledge information regarding the content of the case of damage, and may cause the first language model 100 to extract a keyword related to the content of the case of damage from the document describing the case of damage by further using the input knowledge information. For example, the knowledge information includes a “name” of an organization such as a company and an “explanation” regarding the organization (FIG. 13).

The extraction unit 31 outputs, to the generation unit 32, damage information including the keyword extracted from the input document.

The generation unit 32 inputs, to the second language model 300, the second prompt that includes the second instruction sentence for instructing generation of an explanation of the case of damage and the damage information. Then, the generation unit 32 causes the second language model 300 to output an explanation (FIG. 4) of the case of the damage.

Alternatively, the generation unit 32 further inputs, to the second language model 300, basic information regarding a certain type of vulnerability in information security. The generation unit 32 may cause the second language model 300 to refer to the basic information stored in a basic information DB (not illustrated) and to output an explanation regarding the case of damage from the damage information and the basic information.

Furthermore, in a modified example, the generation unit 32 may cause the second language model 300 to refer to the knowledge information DB 400 (FIG. 10) and to output an explanation regarding the case of damage by using, in addition to the damage information or in addition to the damage information and the basic information, the knowledge information. For example, the knowledge information includes a “name” of an organization such as a company and an “explanation” regarding the organization (FIG. 13).

Furthermore, in another modified example, when a large amount of information exists in one item of damage information, such as when there are one hundred affected companies, the generation unit 32 may summarize such information and perform natural generation of a summary. In this case, for example, the second prompt is supplemented with “#summary or higher-level concept of type of each piece of damage information-affected company: IT service company, affected product name: firewall”, and the instruction sentence is supplemented with “#please refer to the summary or higher-level concept of type of each piece of damage information, and collectively extract the type of damage information as higher-level concept”.

The generation unit 32 outputs the explanation regarding the case of damage generated based on the damage information by the second language model 300, to the output unit 13.

Similarly to the first example embodiment, the output unit 13 outputs information based on the explanation generated by the generation unit 32.

For example, the output unit 13 receives the explanation regarding the case of damage from the generation unit 32. The output unit 13 outputs, to an external device (not illustrated) such as a user terminal, either information based on the explanation regarding the case of damage or the explanation regarding the case of damage itself generated by the second language model 300.

### Example of Second Prompt: Part 1

FIG. 11 illustrates an example of the second prompt that includes the second instruction sentence for designating a keyword related to the content of the case of damage, the basic information, and the damage information. In the example illustrated in FIG. 11, the second instruction sentence is “The following information is an explanation regarding CVE-oooo-xxxxx. Please summarize and output latest information on vulnerability from the following #basic information and #damage information. The #damage information indicates each case, and please output an explanation such that the relationships among the cases are not lost”. The “basic information” is “This vulnerability is caused by the ΔΔΔ setting in the source code of the product xx of company ○○, and allows privilege escalation and arbitrary code execution”. The “damage information” is “Article A: {affected company: company N, amount of damage: 20 billion yen, affected product name: B-1, vendor name: company A, affected country: Japan}, Article B: {affected company: company F, amount of damage: 40 billion yen, affected product name: B-1, vendor name: company A, affected country: the United States}”.

### Example of Second Prompt: Part 2

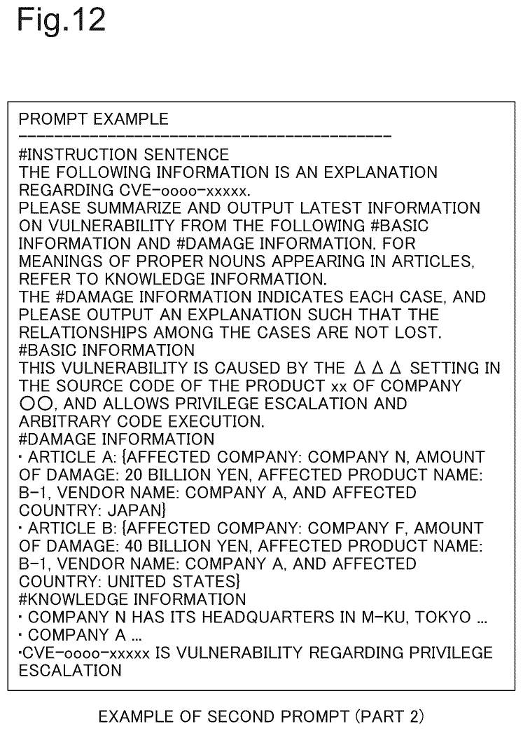

FIG. 12 illustrates another example of the second prompt that includes the second instruction sentence for designating a keyword related to the content of the case of damage, the basic information, and the damage information. In the example illustrated in FIG. 12, the second instruction sentence is “The following information is an explanation regarding CVE-oooo-xxxxx. Please summarize and output latest information on vulnerability from the following #basic information and #damage information. Further, please refer to #knowledge information for the meaning of proper names appearing in the article. The #damage information indicates each case, and please output an explanation such that the relationships among the cases are not lost”. The “basic information” and the “damage information” are the same as those in the above-described example (FIG. 11).

In the example of the second prompt illustrated in FIG. 12, the second language model 300 is caused to output an explanation regarding the case of damage by using the knowledge information in addition to the damage information and the basic information. In this example, the “knowledge information” is “Company N has its headquarters in M-ku, Tokyo . . . ”, “Company A . . . ”, and “CVE-oooo-xxxxx is vulnerability regarding privilege escalation”.

### Example of Knowledge Information

FIG. 13 illustrates an example of knowledge information explained in the example of the second prompt (FIG. 12). In the example illustrated in FIG. 13, the knowledge information includes a company name, a product name, and a vulnerability category, as well as explanations thereof.

### Operation of Text Processing Apparatus 30

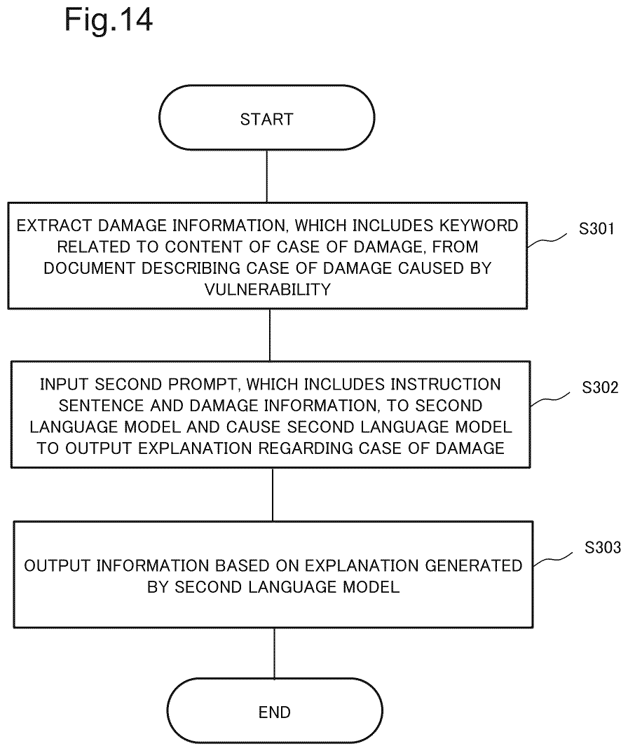

An operation of the text processing apparatus 30 according to the third example embodiment will be described with reference to FIG. 14. FIG. 14 is a flowchart illustrating an operation of the text processing apparatus 30 according to the third example embodiment.

As illustrated in FIG. 14, first, the extraction unit 31 extracts damage information which includes a keyword related to content of a case of damage, from the documents (FIG. 2) describing the cases of damage caused by a vulnerability (S301). The extraction unit 31 outputs the damage information extracted from the document describing the case of damage, to the generation unit 32.

Next, the generation unit 32 inputs, to the second language model 300, the second prompt including the damage information extracted from the document by the extraction unit 31, and causes the second language model 300 to output an explanation regarding the case of damage (S302). The generation unit 32 outputs the explanation regarding the case of damage output by the second language model 300, to the output unit 13.

Then, the output unit 13 outputs information based on the generated explanation (S303).

As described above, the operation of the text processing apparatus 30 according to the third example embodiment ends.

### Effects of Present Example Embodiment

With the configuration of the present example embodiment, the extraction unit 31 extracts damage information which includes a keyword related to content of the case of damage, from the document describing the case of damage caused by a vulnerability. The generation unit 32 inputs, to the second language model 300, the second prompt including the second instruction sentence and the damage information, and causes the second language model 300 to output an explanation regarding the case of damage. The output unit 13 outputs information based on the explanation generated by the second language model 300.

In this manner, the text processing apparatus 30 first extracts damage information from a document, then generates an explanation regarding the case of damage by using the extracted damage information, and outputs the explanation. Therefore, the output explanation (summary) includes damage information including a keyword related to content of a case of damage.

As a result, it is possible to ensure that information regarding a case of damage regarding a certain type of vulnerability in information security is included in a summary of a document describing the case of damage.

### Fourth Example Embodiment

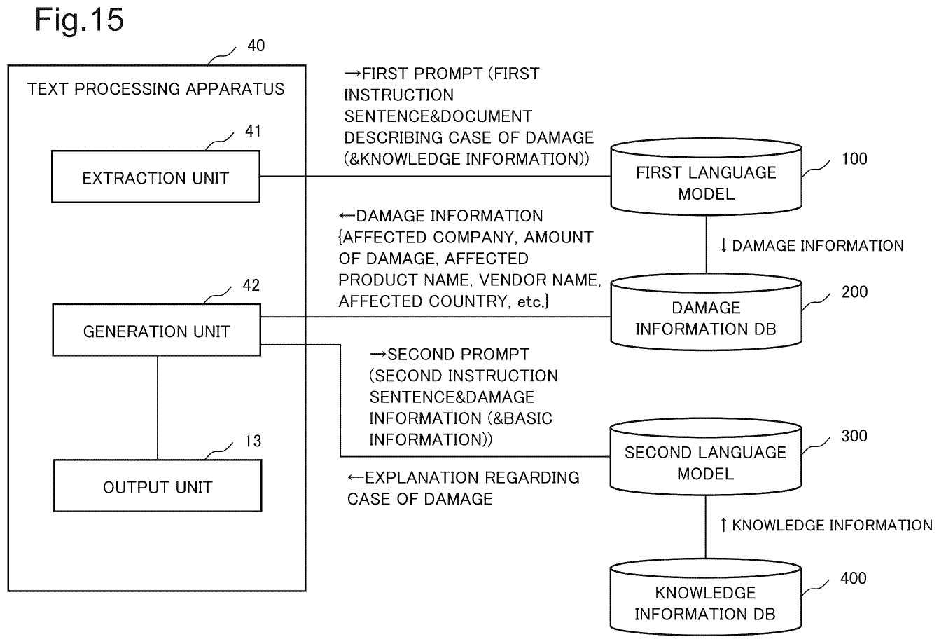

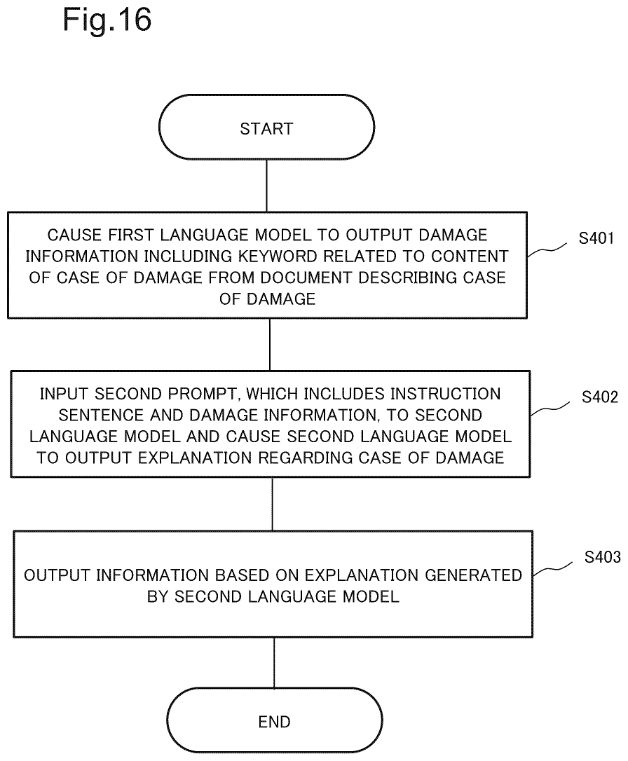

A fourth example embodiment of the present disclosure will be described with reference to FIGS. 15 and 16. In the fourth example embodiment, the same components as those in the first example embodiment are denoted by the same reference numerals as those in the first example embodiment, and the description thereof may be omitted.

### Configuration of Text Processing Apparatus 40

FIG. 15 is a block diagram illustrating a configuration of a text processing apparatus 40 according to the fourth example embodiment. As illustrated in FIG. 15, the text processing apparatus 40 includes an extraction unit 41, a generation unit 42, and the output unit 13.

The extraction unit 41 inputs, to the first language model 100, the first prompt (FIG. 7) that includes the first instruction sentence for designating a keyword related to the content of the case of damage and the document describing the case of damage. Then, the extraction unit 41 may cause the first language model 100 to output, from the input document, damage information including a keyword related to the content of the case of damage. The extraction unit 41 is an example of extraction means. For example, the keyword related to the content of the case of damage includes an affected company name, an affected product name, a vendor name, and an affected country name.

Alternatively, the extraction unit 41 further inputs, to the first language model 100, basic information regarding a certain type of vulnerability in information security, and causes the first language model 100 to refer to the input basic information and to extract a keyword related to the content of the case of damage from the document describing the case of damage.

The extraction unit 41 stores the damage information including a keyword extracted from the document describing the case of damage, in the damage information database (DB) 200.

The generation unit 42 inputs, to the second language model 300, the second prompt that includes the second instruction sentence for instructing generation of an explanation of the case of damage and the damage information. Then, the generation unit 42 causes the second language model 300 to output an explanation (FIG. 4) of the case of the damage.

Alternatively, the generation unit 42 further inputs, to the second language model 300, knowledge information regarding content of the case of damage. The generation unit 42 may cause the second language model 300 to refer to the knowledge information stored in the knowledge information DB 400 (FIG. 15) and to output an explanation regarding the case of damage from the damage information and the knowledge information. For example, the knowledge information includes a “name” of an organization such as a company and an “explanation” regarding the organization (FIG. 13).

Furthermore, in a modified example, the generation unit 42 may cause the second language model 300 to output an explanation regarding the case of damage by using, in addition to the damage information or in addition to the damage information and the knowledge information, basic information regarding a certain type of vulnerability in information security.

The generation unit 42 outputs the explanation regarding the case of damage generated based on the damage information by the second language model 300, to the output unit 13.

Similarly to the first example embodiment, the output unit 13 outputs information based on the explanation generated by the generation unit 42.

For example, the output unit 13 receives the explanation regarding the case of damage from the generation unit 42. The output unit 13 outputs, to an external device (not illustrated) such as a user terminal, either information based on the explanation regarding the case of damage or the explanation regarding the case of damage itself generated by the second language model 300.

### Operation of Text Processing Apparatus 40

An operation of the text processing apparatus 40 according to the fourth example embodiment will be described with reference to FIG. 16. FIG. 16 is a flowchart illustrating an operation of the text processing apparatus 40 according to the fourth example embodiment.

As illustrated in FIG. 16, the extraction unit 41 causes the first language model 100 to output damage information which includes a keyword related to content of a case of damage, from a document describing the case of damage caused by a certain type of vulnerability in information security (S401). The extraction unit 41 stores the damage information extracted from the input document, in the damage information DB 200.

Next, the generation unit 42 inputs, to the second language model 300, the second prompt including the damage information stored in the damage information DB 200, and causes the second language model 300 to output an explanation regarding the case of damage (S402). The generation unit 42 outputs the explanation regarding the case of damage output by the second language model 300, to the output unit 13.

Then, the output unit 13 outputs information based on the generated explanation (S403).

As described above, the operation of the text processing apparatus 40 according to the fourth example embodiment ends.

### Effects of Present Example Embodiment

With the configuration of the present example embodiment, the extraction unit 41 causes the first language model 100 to output damage information which includes a keyword related to content of a case of damage, from a document describing the case of damage caused by a certain type of vulnerability in information security. The generation unit 42 inputs, to the second language model 300, the second prompt including the second instruction sentence and the damage information, and causes the second language model 300 to output an explanation regarding the case of damage. The output unit 13 outputs information based on the explanation generated by the second language model 300.

In this manner, the text processing apparatus 40 first extracts damage information from a document, then generates an explanation regarding the case of damage by using the extracted damage information, and outputs the explanation. Therefore, the output explanation (summary) includes damage information including a keyword related to content of a case of damage.

As a result, it is possible to ensure that information regarding a case of damage regarding a certain type of vulnerability in information security is included in a summary of a document describing the case of damage.

### Hardware Configuration

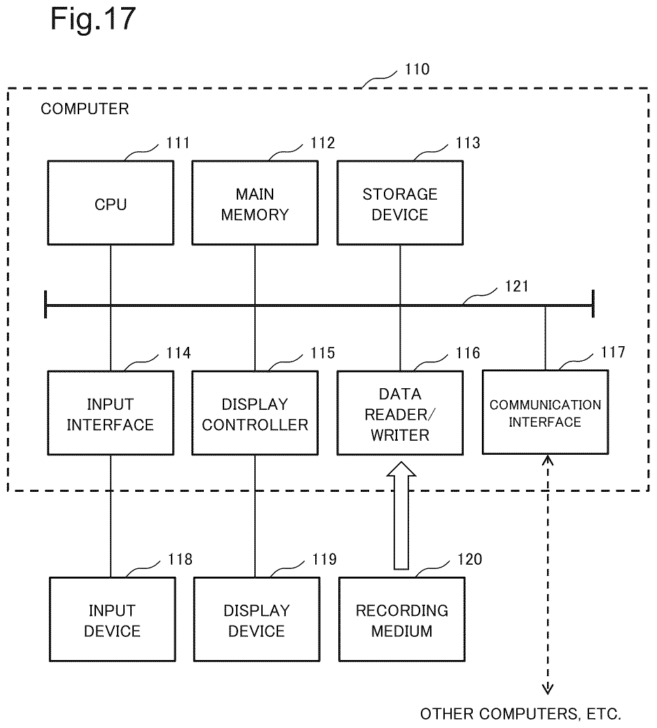

Each component of the text processing apparatuses 10, 20, 30, and 40 described in the first to fourth example embodiments represents a block of a functional unit. Some or all of these components are achieved by, for example, a text processing apparatus as illustrated in FIG. 17. FIG. 17 is a block diagram illustrating an example of a hardware configuration of the text processing apparatus.

As illustrated in FIG. 17, a computer 110 includes a Central Processing Unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a Graphics Processing Unit (GPU) or a Field-Programmable Gate Array (FPGA) in addition to the CPU 111 or instead of the CPU 111.

The CPU 111 loads programs (codes) in the present example embodiment, which are stored in the storage device 113, into the main memory 112, and executes them in a predetermined order to perform various operations. The main memory 112 is typically a volatile storage device such as a Dynamic Random Access Memory (DRAM). The programs in the present example embodiment are provided in a state of being stored in a computer-readable recording medium 120. The programs in the present example embodiment may be distributed on the Internet connected via the communication interface 117.

Specific examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates data transmission between the CPU 111 and the recording medium 120, reads a program from the recording medium 120, and writes a processing result of the computer 110 into the recording medium 120. The communications interface 117 mediates data transmission between the CPU 111 and another computer.

Specific examples of the recording medium 120 include general-purpose semiconductor storage devices such as Compact Flash (CF) (registered trademark) and a Secure Digital (SD), a magnetic recording medium such as a Flexible Disk, and an optical recording medium such as a Compact Disk Read Only Memory (CD-ROM).

### Supplementary Note

Some or all of the above example embodiments can also be described as the following Supplementary Notes, but are not limited to the following.

### Supplementary Note 1

A text processing apparatus including:
extraction means for extracting damage information including a keyword related to content of a case of damage caused by a certain type of vulnerability in information security, from a document describing the case of damage;
generation means for generating an explanation regarding the case of damage by using the damage information extracted from the document; and
output means for outputting information based on the generated explanation.

### Supplementary Note 2

The text processing apparatus according to Supplementary Note 1, in which
the extraction means inputs, to a first language model, a first prompt that includes a first instruction sentence for designating the keyword related to the content of the case of damage and the document, and causes the first language model to output the damage information including the keyword related to the content of the case of damage from the document.

### Supplementary Note 3

The text processing apparatus according to supplementary note 2, in which
the extraction means
   further inputs, to the first language model, knowledge information regarding the certain type of vulnerability in information security, and
   causes the first language model to refer to the knowledge information and to extract the keyword related to the content of the case of damage from the document.

### Supplementary Note 4

The text processing apparatus according to Supplementary Note 1, in which the extraction means stores the damage information including the keyword extracted from the document, in a damage information database.

### Supplementary Note 5

The text processing apparatus according to Supplementary Note 4, in which
the generation means generates the explanation regarding the case of damage by referring to the damage information stored in the damage information database.

### Supplementary Note 6

The text processing apparatus according to any one of Supplementary Notes 1 to 4, in which
the generation means
   inputs a second prompt that includes a second instruction sentence for instructing generation of an explanation of the case of damage and the damage information, to a second language model, and
   causes the second language model to output the explanation regarding the case of damage.

### Supplementary Note 7

The text processing apparatus according to Supplementary Note 6, in which
the generation means
   further inputs basic information regarding the certain type of vulnerability in information security, to the second language model, and
   causes the second language model to refer to the basic information and to output the explanation regarding the case of damage from the damage information and the basic information.

### Supplementary Note 8

The text processing apparatus according to Supplementary Note 6 or 7, in which
the generation means
   further inputs knowledge information regarding the content of the case of damage to the second language model, and
   causes the second language model to refer to the knowledge information and to output the explanation regarding the case of damage from the damage information and the knowledge information.

### Supplementary Note 9

The text processing apparatus according to Supplementary Note 1, in which
the output means outputs information regarding the certain type of vulnerability in information security and information regarding the case of damage.

### Supplementary Note 10

The text processing apparatus according to Supplementary Note 1, in which
the document includes an article in which the case of damage caused by the certain type of vulnerability in information security is written.

### supplementary Note 11

The text processing apparatus according to Supplementary Note 1, in which
the keyword includes at least one of a name of an organization that sustained damage caused by the certain type of vulnerability in information security, an amount of damage, a name of a product having the vulnerability, and a country that sustained damage. Supplementary Note 12

The text processing apparatus according to Supplementary Note 1, in which
the basic information includes a feature of the certain type of vulnerability in information security.

### Supplementary Note 13

A text processing method executed by a computer, the text processing method including:
extracting damage information including a keyword related to content of a case of damage caused by a certain type of vulnerability in information security, from a document describing the case of damage;
generating an explanation regarding the case of damage by using the damage information extracted from the document; and
outputting information based on the generated explanation.

### Supplementary Note 14

A program for causing a computer to execute:
process of extracting damage information including a keyword related to content of a case of damage caused by a certain type of vulnerability in information security, from a document describing the case of damage;
process of generating an explanation regarding the case of damage by using the damage information extracted from the document; and
process of outputting information based on the generated explanation.

Some or all of the configurations described in Supplementary Notes 2 to 12 dependent on the above-described Supplementary Note 1 (ex. text processing apparatus) can also be dependent on Supplementary Note 13 (ex. text processing method) and Supplementary Note 14 (ex. program) by the same dependency relationship as Supplementary Notes 2 to 12. Some or all of the configurations described as Supplementary Notes can be similarly dependent on various hardware, software, recording means for recording software, or systems without departing from the above-described example embodiments.

The present disclosure has been described above with reference to several example embodiments. However, the present disclosure is not limited to the above example embodiments. Each example embodiment can be appropriately combined with other example embodiments. Various modifications, which can be understood by those skilled in the art, can be made to the configuration and details of the above example embodiments within the scope of the present disclosure.

The present disclosure can be used in a text processing apparatus that generates a summary of an input document.

1. A text processing apparatus comprising:
a memory configured to store instructions; and
at least one processor configured to execute the instructions to perform:
extracting damage information including a keyword related to content of a case of damage caused by a certain type of vulnerability in information security, from a document describing the case of damage;
generating an explanation regarding the case of damage by using the damage information extracted from the document; and
outputting information based on the generated explanation.

2. The text processing apparatus according to claim 1, wherein
the at least one processor is configured to execute the instructions to perform:
inputting, to a first language model, a first prompt that includes a first instruction sentence for designating the keyword related to the content of the case of damage and the document, and causes the first language model to output the damage information including the keyword related to the content of the case of damage from the document.

3. The text processing apparatus according to claim 2, wherein
the at least one processor is further configured to execute the instructions to perform:
inputting, to the first language model, knowledge information regarding the certain type of vulnerability in information security, and
causing the first language model to refer to the knowledge information and to extract the keyword related to the content of the case of damage from the document.

4. The text processing apparatus according to claim 1, wherein
the at least one processor is configured to execute the instructions to perform:
storing the damage information including the keyword extracted from the document, in a damage information database.

5. The text processing apparatus according to claim 4, wherein
the at least one processor is configured to execute the instructions to perform:
generating the explanation regarding the case of damage by referring to the damage information stored in the damage information database.

6. The text processing apparatus according to claim 1, wherein
the at least one processor is configured to execute the instructions to perform:
inputting a second prompt that includes a second instruction sentence for instructing generation of an explanation of the case of damage and the damage information, to a second language model, and
causes the second language model to output the explanation regarding the case of damage.

7. The text processing apparatus according to claim 6, wherein
the at least one processor is further configured to execute the instructions to perform:
inputting basic information regarding the certain type of vulnerability in information security, to the second language model, and
causing the second language model to refer to the basic information and to output the explanation regarding the case of damage from the damage information and the basic information.

8. The text processing apparatus according to claim 6, wherein
the at least one processor is further configured to execute the instructions to perform:
inputting knowledge information regarding the content of the case of damage to the second language model, and
causing the second language model to refer to the knowledge information and to output the explanation regarding the case of damage from the damage information and the knowledge information.

9. The text processing apparatus according to claim 1, wherein
the at least one processor is configured to execute the instructions to perform:
outputting information regarding the certain type of vulnerability in information security and information regarding the case of damage.

10. The text processing apparatus according to claim 1, wherein
the document includes an article in which the case of damage caused by the certain type of vulnerability in information security is written.

11. The text processing apparatus according to claim 1, wherein
the keyword includes at least one of a name of an organization that sustained damage caused by the certain type of vulnerability in information security, an amount of damage, a name of a product having the vulnerability, and a country that sustained damage.

12. The text processing apparatus according to claim 7, wherein
the basic information includes a feature of the certain type of vulnerability in information security.

13. A text processing method executed by a computer, the text processing method comprising:
extracting damage information including a keyword related to content of a case of damage caused by a certain type of vulnerability in information security, from a document describing the case of damage;
generating an explanation regarding the case of damage by using the damage information extracted from the document; and
outputting information based on the generated explanation.

14. A non-transitory recording medium storing a program for causing a computer to execute:
process of extracting damage information including a keyword related to content of a case of damage caused by a certain type of vulnerability in information security, from a document describing the case of damage;
process of generating an explanation regarding the case of damage by using the damage information extracted from the document; and
process of outputting information based on the generated explanation.
